(19) United States
(12) Patent Application Publication
(10) Pub. No.: US 2014/0379577 A1
(43) Pub. Date: Dec. 25, 2014

(54) METHODS, SYSTEMS, AND COMPUTER-READABLE MEDIA FOR PROVIDING FINANCIAL TRANSACTIONS

(71) Applicant: Infosys Limited, Bangalore (IN)

(72) Inventor: Gautam Bandyopadhyay, Bangalore (IN)

(73) Assignee: Infosys Limited, Bangalore (IN)

(21) Appl. No.: 14/220,654

(22) Filed: Mar. 20, 2014

(30) Foreign Application Priority Data
Jun. 24, 2013 (IN) 2904/CHE/2013

(51) Int. Cl. G06Q 20/40

(52) U.S. Cl. CPC G06Q 20/409
USPC 705/44

(57) ABSTRACT

The present invention relates to computer-implemented methods, systems and computer-readable media for providing financial transactions. The method steps comprise initializing at least one transaction from a customer held device, wherein initializing comprises entering a network provider code, an acquiring institution number, a merchant identification number, a terminal identification number and sending a transaction request to an issuing institution. The method further comprises authenticating said transaction by said issuing institution, wherein authenticating comprises confirming said transaction by said issuing institution, sending said confirmation transaction to an acquiring institution and routing the confirmation to said terminal identification number by said acquiring institution and terminating said transaction at a merchant held device.

### RELATED APPLICATION

This application claims the benefit of Indian Patent Application Filing No. 2904/CHE/2013, filed Jun. 24, 2013, which is hereby incorporated by reference in its entirety.

### FIELD

The present invention relates to financial applications for digitizing physical payments. More particularly, the invention is concerned with computer-implemented methods, systems and computer-readable media for providing financial transactions.

### BACKGROUND

The point of sale terminals or hand held terminals are currently loaded with application that reads the data from a card swiped or in the more recent forms—receives an equivalent of card swipe through NFC or other means such as DTF. Card information and along payment details then travels to the acquiring system and finally through payment networks such as Master, Visa, Diners, etc., the information travels to the issuing bank. Issuing bank authenticates the transaction and the confirmation travels back to the merchant till, where a receipt is printed.

The current technology evolution in the market is happening in two ways. One way is that developments around NFC where the NFC donor devices and NFC receiver devices are being programmed to fulfill “card emulation” type of transactions. The second way is that work is happening in card-not-present paradigm for remote merchant payments.

The limitations of the existing technology are such that it does not amend to the new ways of initiating payments directly by the consumer. It means that if a mobile phone or hand-held device in the hands of the consumer wants to communicate card and payment details to the merchant using a “card emulation” mechanism without actually swiping a physical card.

Thus, there is a need to overcome the problems of the existing technology. Therefore, the present inventors have developed computer-implemented methods, systems and computer-readable media for providing about computer-implemented methods, systems and computer-readable media for providing financial transactions. It would enable “card emulations” by consumers without requiring a change in the merchant EDC or card payment acceptance device and create an effective alternative to pass payment details in a secured way.

### SUMMARY

The present invention discloses a computer implemented method executed by one or more computing devices for providing financial transactions. The method comprises the steps of initializing at least one transaction from a customer held device, wherein initializing comprises entering a network provider code, an acquiring institution number, a merchant identification number, a terminal identification number and sending a transaction request to an issuing institution. The method further comprises authenticating said transaction by said issuing institution, wherein authenticating comprises confirming said transaction by said issuing institution, sending said confirmation transaction to an acquiring institution and routing the confirmation to said terminal identification number by said acquiring institution, and terminating said transaction at a merchant held device.

The present invention further discloses a system for providing financial transactions. The system comprises a memory, and a processor operatively coupled to the memory. The processor is configured to perform the steps of initializing at least one transaction from a customer held device, wherein initializing comprises entering a network provider code, an acquiring institution number, a merchant identification number, a terminal identification number and sending a transaction request to an issuing institution. The method further comprises authenticating said transaction by said issuing institution, wherein authenticating comprises confirming said transaction by said issuing institution, sending said confirmation transaction to an acquiring institution and routing the confirmation to said terminal identification number by said acquiring institution, and terminating said transaction at a merchant held device.

Additionally, the present invention discloses computer-readable code stored on a non-transitory computer-readable medium that when executed by a computing device performs a method for providing financial transactions. The method comprises initializing at least one transaction from a customer held device, wherein initializing comprises entering a network provider code, an acquiring institution number, a merchant identification number, a terminal identification number and sending a transaction request to an issuing institution. The method further comprises authenticating said transaction by said issuing institution, wherein authenticating comprises confirming said transaction by said issuing institution, sending said confirmation transaction to an acquiring institution and routing the confirmation to said terminal identification number by said acquiring institution, and terminating said transaction at a merchant held device.

### BRIEF DESCRIPTION OF THE DRAWINGS

Features, aspects, and advantages of the present invention will be better understood when the following detailed description is read with reference to the accompanying drawings in which like characters represent like parts throughout the drawings.

FIG. 1 shows a conventional process of card transactions for paying physical merchants.

FIG. 2 is a flow chart depicting a process of card emulation.

FIG. 3 is a flow chart illustrating a method for providing card transactions for paying physical merchants in a reverse flow, in accordance with an embodiment of the present invention.

FIG. 4 illustrates a block diagram, illustrating a system for identifying one or more components, in accordance with an embodiment of the present invention.

FIG. 5 shows a generalized computer network arrangement, in one embodiment of the present technique.

While systems and methods are described herein by way of example and embodiments, those skilled in the art recognize that systems and methods for providing financial transactions are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

The following description is a full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

As a preliminary matter, the definition of the term “or” for the purpose of the following discussion and the appended claims is intended to be an inclusive “or” That is, the term “or” is not intended to differentiate between two mutually exclusive alternatives. Rather, the term “or” when employed as a conjunction between two elements is defined as including one element by itself, the other element itself, and combinations and permutations of the elements. For example, a discussion or recitation employing the terminology “A” or “B” includes: “A” by itself, “B” by itself and any combination thereof, such as “AB” and/or “BA.” It is worth noting that the present discussion relates to exemplary embodiments, and the appended claims should not be limited to the embodiments discussed herein.

Disclosed embodiments provide computer-implemented methods, systems, and computer-readable media for providing financial transactions. The present invention provides a method of enabling “card emulation” by enabling consumers to initiate and fulfill payment transactions without requiring change in the merchant device to receive the transaction.

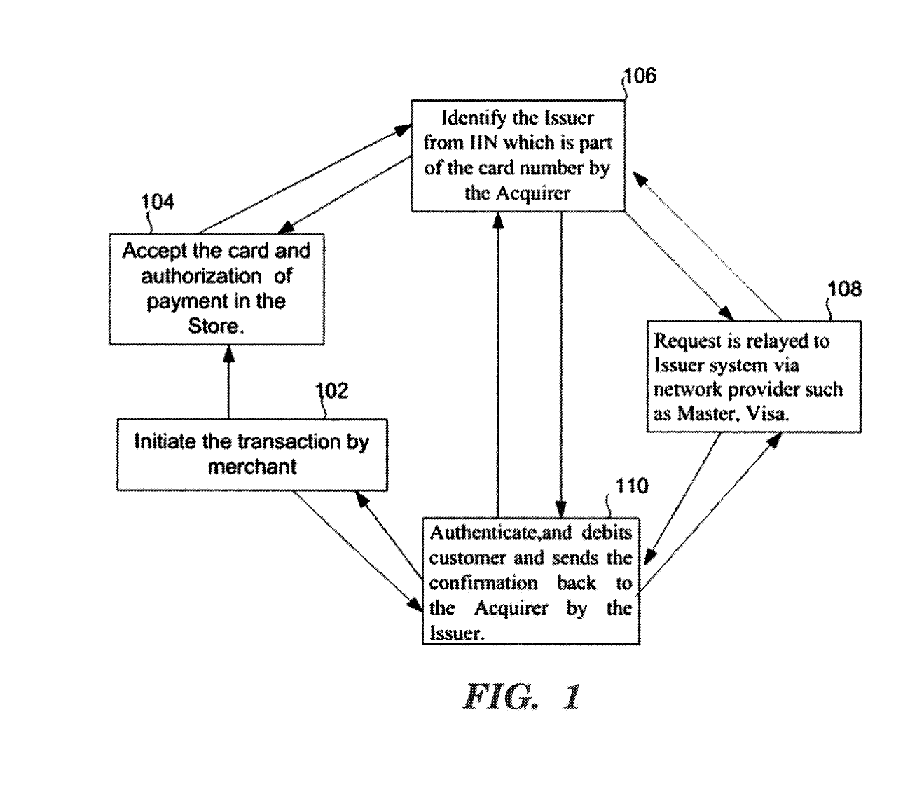

FIG. 1 shows a conventional process of card transactions for paying physical merchants. The process steps include initiating the current transaction process by a merchant (102), swiping the card at EDC machines by the merchant, accepting the card and authorization of payment in the Store (104), identifying the Issuer from IIN which is part of the card number by the Acquirer (106), requesting is relayed to the Issuer system (via network provider such as Master, Visa) (108), authenticating and debiting customer and sending the confirmation back to the Acquirer by the Issuer and sending back the confirmation to merchant terminal by the Acquirer (110).

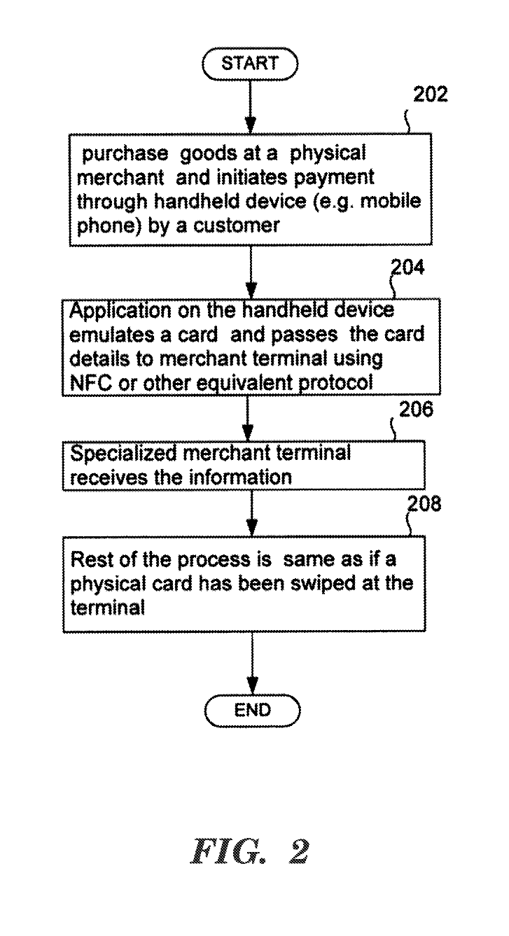

FIG. 2 illustrates process steps involved in card emulation. In this process, customer purchases goods at a physical merchant and initiates payment through a handheld device (e.g. mobile phone) (202). Application on the handheld device emulates a card and passes the card details to merchant terminal using NFC or other equivalent protocol (204). Then, specialized merchant terminal receives the information (206). The rest of the process remains the same as if a physical card has been swiped at the terminal (208).

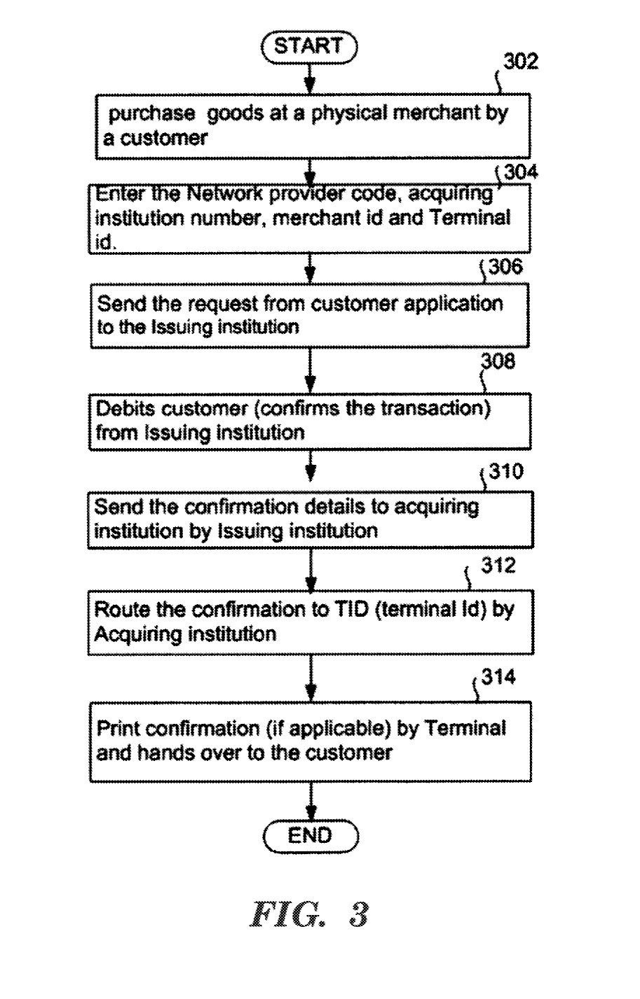

FIG. 3 shows the process steps of card transactions for paying physical merchants in a reverse flow. The process steps comprise initializing at least one transaction from a customer held device i.e. customer purchases goods (302). The merchant held device comprises a merchant POS or an EDC machine. The customer application enters the Network provider code acquiring institution number, merchant identification number (MID) and terminal identification number (TID) (304). The network provider code is a master card code or visa card code/or Amex etc. The merchant identification number and terminal identification number are issued by the acquiring institution. The customer application sends the request to the Issuing institution (306) then the Issuing institution confirming said transaction (308) and sends the confirmation details to the acquiring institution (310). The acquiring institution routes the confirmation to TID (Terminal Id) (312) and print the confirmation by terminal and hands over to the customer (314).

In the present process, user initiated merchant payment using “card emulation” using the process, explained in the FIG. 3, which does not require changes in merchant terminals. Consumers can use cards or card proxies stored either in their hand-held devices, mobile phones or similar devices or stored at a backend server/service and accessed through their hand-held devices, mobile phones or similar devices and communicate with the EDC/POS/Merchant devices without the merchant device having to make any change to receive a specialized communication such as NFC. The present process therefore addresses the segment of physical merchant payments and works in a way that does not require change at the device end.

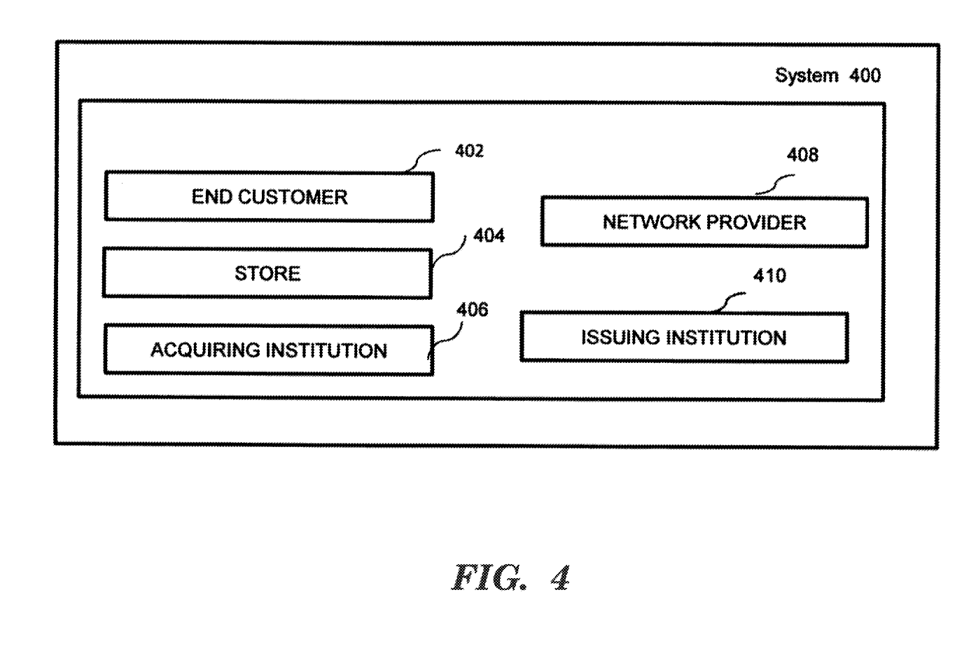

FIG. 4 is a block diagram, illustrating a system 400 for identifying one or more components, in accordance with an embodiment of the present invention. More particularly, in FIG. 4 the system includes elements such as an initiation of transaction by an end customer (402), Store (404) having a merchant held device such as a merchant POS or an EDC machine, Acquirer or Acquiring institution (406), Network provider (408) and Issuer or Issuing institution (410).

In the FIG. 4, the end customer (402) is the initiator of the transaction and also responsible for eventually settling the transaction with the issuer. The Store (404) accepts the card as a payment authorization and delivers merchandise. Acquirer (406) acquires merchant by providing EDC to accept card payments, charges a fee for each card transaction and authorizes merchant requests. Network provider (408) provides the service which acquires can contact to authorize payment from any issuer. It charges a fee to the acquirer for each authorization request. Issuer (410) issues cards to the consumer and is responsible for authorizing the payment request. It charges an interchange fee for bearing the credit risk on behalf of the consumer.

### Exemplary Computing Environment

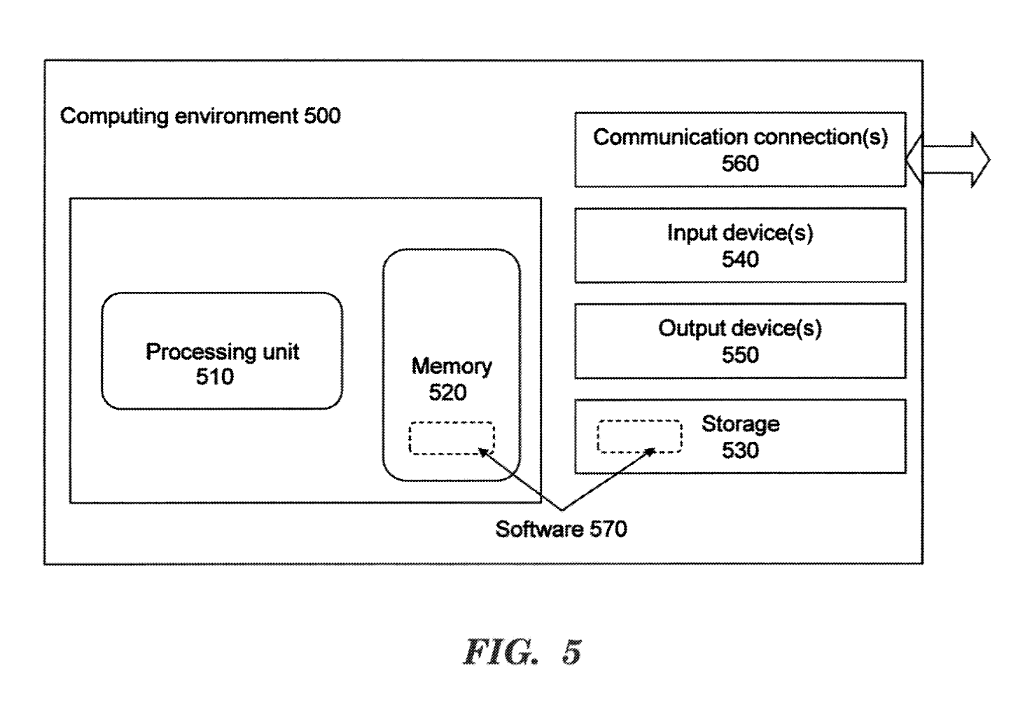

One or more of the above-described techniques may be implemented in or involve one or more computer systems. FIG. 5 shows a generalized example of a computing environment 500. The computing environment 500 is not intended to suggest any limitation as to scope of use or functionality of described embodiments.

With reference to FIG. 5, the computing environment 500 includes at least one processing unit 510 and memory 520. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM), non-volatile memory (e.g., ROM, EEPROM, flash memory, etc.), or some combination of the two. In some embodiments, the memory 520 stores software 570 implementing described techniques.

A computing environment may have additional features. For example, the computing environment 500 includes storage 530, one or more input devices 540, one or more output devices 550, and one or more communication connections 560. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The storage 530 may be removable or non-removable, and includes magnetic disks, magnetic tapes or cassettes, CD-ROMs, CD-RWs, DVDs, or any other medium which may be used to store information and which may be accessed within the computing environment 500. In some embodiments, the storage 430 stores instructions for the software 570.

The input device(s) 540 may be a touch input device such as a keyboard, mouse, pen, trackball, touch screen, or game controller, a voice input device, a scanning device, a digital camera, or another device that provides input to the computing environment 500. The output device(s) 550 may be a display, printer, speaker, or another device that provides output from the computing environment 500.

The communication connection(s) 560 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 500, computer-readable media include memory 520, storage 530, communication media, and combinations of any of the above.

Having described and illustrated the principles of our invention with reference to described embodiments, it will be recognized that the described embodiments may be modified in arrangement and detail without departing from such principles.

In view of the many possible embodiments to which the principles of our invention may be applied, we claim as our invention all such embodiments as may come within the scope and spirit of the claims and equivalents thereto.

While the present invention has been related in terms of the foregoing embodiments, those skilled in the art will recognize that the invention is not limited to the embodiments depicted. The present invention may be practiced with modification and alteration within the spirit and scope of the appended claims. Thus, the description is to be regarded as illustrative instead of restrictive on the present invention.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The detailed description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer-implemented method executed by one or more computing devices for providing financial transactions, said method comprising:
initializing at least one transaction from a customer held device, wherein initializing comprises entering a network provider code, an acquiring institution number, a merchant identification number, and a terminal identification number and sending a transaction request to an issuing institution;
authenticating said transaction by said issuing institution, wherein authenticating comprises confirming said transaction by said issuing institution, sending said confirmation transaction to an acquiring institution and routing the confirmation to said terminal identification number by said acquiring institution; and
terminating said transaction at a merchant held device.

2. The method of claim 1, wherein said network provider code comprises an issuer card code.

3. The method of claim 2, wherein the issuer card code is a master card code or a visa card code.

4. The method of claim 1, wherein said merchant identification number is issued by said acquiring institution.

5. The method of claim 1, wherein said terminal identification number is issued by said acquiring institution.

6. The method of claim 1, wherein said merchant held device comprises a merchant POS or an EDC machine.

7. A system for providing financial transactions comprising:
a memory; and
a processor operatively coupled to the memory, the processor configured to perform the steps of:
initializing at least one transaction from a customer held device, wherein initializing comprises entering a network provider code, an acquiring institution number, a merchant identification number, a terminal identification number and sending a transaction request to an issuing institution;
authenticating said transaction by said issuing institution, wherein authenticating comprises confirming said transaction by said issuing institution, sending said confirmation transaction to an acquiring institution and routing the confirmation to said terminal identification number by said acquiring institution ; and
terminating said transaction at a merchant held device.

8. The system of claim 7, wherein said network provider code comprises an issuer card code.

9. The system of claim 8, wherein the issuer card code is a master card code or a visa card code.

10. The system of claim 7, wherein said merchant identification number is issued by said acquiring institution.

11. The system of claim 7, wherein said terminal identification number is issued by said acquiring institution.

12. The system of claim 7, wherein said merchant held device comprises a merchant POS or an EDC machine.

13. Computer-readable code stored on a non-transitory computer-readable medium that, when executed by a computing device, performs a method for providing financial transactions, the method comprising:
initializing at least one transaction from a customer held device, wherein initializing comprises entering a network provider code, an acquiring institution number, a merchant identification number, a terminal identification number and sending a transaction request to an issuing institution;
authenticating said transaction by said issuing institution, wherein authenticating comprises confirming said transaction by said issuing institution, sending said confirmation transaction to an acquiring institution and routing the confirmation to said terminal identification number by said acquiring institution ; and
terminating said transaction at a merchant held device.

14. The computer-readable medium of claim 13, wherein said network provider code comprises an issuer card code.

15. The computer-readable medium of claim 14, wherein the issuer card code is a master card code or a visa card code.

16. The computer-readable medium of claim 13, wherein said merchant identification number is issued by said acquiring institution.

17. The computer-readable medium of claim 13, wherein said terminal identification number is issued by said acquiring institution.

18. The computer-readable medium of claim 13, wherein said merchant held device comprises a merchant POS or an EDC machine.
